(19) United States
(12) Patent Application Publication
(10) Pub. No.: US 2018/0308362 A1
(43) Pub. Date: Oct. 25, 2018

(54) DIFFERENTIAL DETECTION DEVICE AND DIFFERENTIAL DETECTION METHOD

(71) Applicant: Panasonic Intellectual Property Management Co., Ltd., Osaka (JP)

(72) Inventors: TSUKASA OKADA, Osaka (JP); TOMOHIDE ISHIGAMI, Osaka (JP)

(21) Appl. No.: 15/897,015

(22) Filed: Feb. 14, 2018

(30) Foreign Application Priority Data
Apr. 24, 2017 (JP) 2017-085682
Sep. 25, 2017 (JP) 2017-183699

(51) Int. Cl. G08G 1/16; G01C 21/32; G06K 9/00

(52) U.S. Cl. CPC G08G 1/163; B60R 2021/0093; G06K 9/00785; G01C 21/32

(57) ABSTRACT

A differential detection device detects a spatial difference. A measurement unit measures a position of each of a plurality of points in a surrounding local space. An extractor extracts attribute information on each of measured voxels that are three-dimensionally arranged and associated with the local space, from a measurement result of the measurement unit. A map management unit manages attribute information on each of map voxels that are three-dimensionally arranged and associated with the space shown on a map. A parameter setting unit sets a numeric value to a parameter according to an operation mode set by the user. A differential detector detects presence or absence of a difference between the attribute information on the measured voxel and the attribute information on the map voxel at a position corresponding to the measured voxel, by using the numeric value set to the parameter. An output unit outputs a detection result.

### BACKGROUND

### 1. Technical Field

The present disclosure relates to differential detection devices for detecting spatial differences, and differential detection methods.

### 2. Description of the Related Art

Differential detection devices for detecting spatial differences have been disclosed (e.g., PTL1).

### CITATION LIST

### Patent Literature

PTL1: Japanese Patent Unexamined Publication No. 2017-16474

### SUMMARY

To use a conventional differential detection device, a parameter to be used for differential detection by the differential detection device needs to be set to an appropriate numeric value according to an environment where the differential detection device will be used, before the differential detection device can be used. The user may thus feel bothered to set the parameter in the conventional differential detection device.

An object of the present disclosure is to offer a differential detection device and a differential detection method that can reduce user's bothersome setting of parameters used in the differential detection device.

The differential detection device of the present disclosure is a differential detection device for detecting a spatial difference, and includes a measurement unit, an extractor, a map management unit, a parameter setting unit, a differential detector, and an output unit. The measurement unit measures a position of each of a plurality of points in a surrounding local space. The extractor extracts attribute information on each measured voxel in a plurality of measured voxels that are three-dimensionally arranged and associated with the local space, from a measurement result of the measurement unit. The map management unit manages attribute information on each map voxel in a plurality of map voxels that are three-dimensionally arranged and associated with the space shown on a map. The parameter setting unit sets a numeric value to a parameter according to an operation mode set by the user. The differential detector detects presence or absence of a difference between the attribute information on the measured voxel and the attribute information on the map voxel at a position corresponding to the measured voxel, by using the numeric value set to the parameter. The output unit outputs a detection result of the differential detector.

A differential detection method of the present disclosure is a method of detecting a spatial difference, and includes a measurement step, an extraction step, a reading step, a parameter setting step, a differential detection step, and an output step. In the measurement step, a position of each of a plurality of points in a surrounding local space is measured. In the extraction step, attribute information on each measured voxel in a plurality of measured voxels that are three-dimensionally arranged and associated with the local space is extracted from a measurement result in the measurement step. In the reading step, attribute information on each map voxel in a plurality of map voxels that are three-dimensionally arranged and associated with the space shown on a map is read. In the parameter setting step, a numeric value is set to a parameter according to an operation mode of the differential detection device set by a user of the differential detection device. In the differential detection step, by using the numeric value set to the parameter, it is detected that presence or absence of a difference between the attribute information on the measured voxel extracted in the extraction step and the attribute information on the map voxel at a position corresponding to the measured voxel read in the reading step. In the output step, a detection result in the differential detection step is output.

The differential detection device and the differential detection method of the present disclosure enable the user to set a parameter used for differential detection just by setting the operation mode. Accordingly, user's bothersome setting of parameters can be eased, compared to the prior art.

### BRIEF DESCRIPTION OF DRAWINGS

FIG. 1 is a schematic perspective view of a scene of using a differential detection device in accordance with a first exemplary embodiment.

FIG. 2 is a block diagram illustrating a functional configuration of the differential detection device in accordance with the first exemplary embodiment.

FIG. 3 is a conceptual diagram of a process of extracting measured voxel data.

FIG. 4 is an example of measured point data.

FIG. 5 is an example of measured voxel data.

FIG. 6 is a flow chart illustrating an example of extraction of attribute information.

FIG. 7 is a flow chart illustrating an example of differential detection.

FIG. 8 is a flow chart illustrating an example of voting in differential detection.

FIG. 9 is a conceptual diagram illustrating how voxel data is classified into spherical, sheet, or linear shape.

FIG. 10 is an example of weighting in voting.

FIG. 11 is an example of calculating similarity 8i of a normal direction indicated by the third principal component in covariance matrix.

FIG. 12A is an example of a data structure of a parameter setting table that is set according to operation modes with different moving speeds.

FIG. 12B is an example of a data structure of a parameter setting table that is set according to operation modes with different measurement cycles.

FIG. 12C is an example of a data structure of a parameter setting table that is set according to operation modes with different usage places.

FIG. 12D is an example of a data structure of a parameter setting table that is set according to operation modes with different ranging devices.

FIG. 13 is a conceptual diagram illustrating a change of the number of measurements of object 1a and the number of votes according to a moving speed of the differential detection device in accordance with the first exemplary embodiment.

FIG. 14 is a flow chart of an example of setting.

FIG. 15 is a block diagram of a functional structure of a differential detection device in accordance with a second exemplary embodiment.

FIG. 16 is an example of a data structure of a parameter setting table for setting a parameter according to voxel size.

FIG. 17 is an exemplary conceptual diagram of an object assumed to be causing a detected difference.

FIG. 18 is an exemplary conceptual diagram of corresponding relation between measured voxel data and map voxel data.

### DETAILED DESCRIPTION

Hereinafter, exemplary embodiments are detailed. The exemplary embodiments described below are all preferred embodiments of the present disclosure. Numeric values, shapes, materials, components; layouts, positions, and connections of components; steps, sequence of steps, and so on described herein are therefore illustrative and not restrictive. The scope of the present disclosure is covered by the claims. Accordingly, components in the exemplary embodiments that are not described in independent claims of the present disclosure may not be always necessary for achieving the present disclosure, but described herein as a structure for further preferred embodiments.

### First Exemplary Embodiment

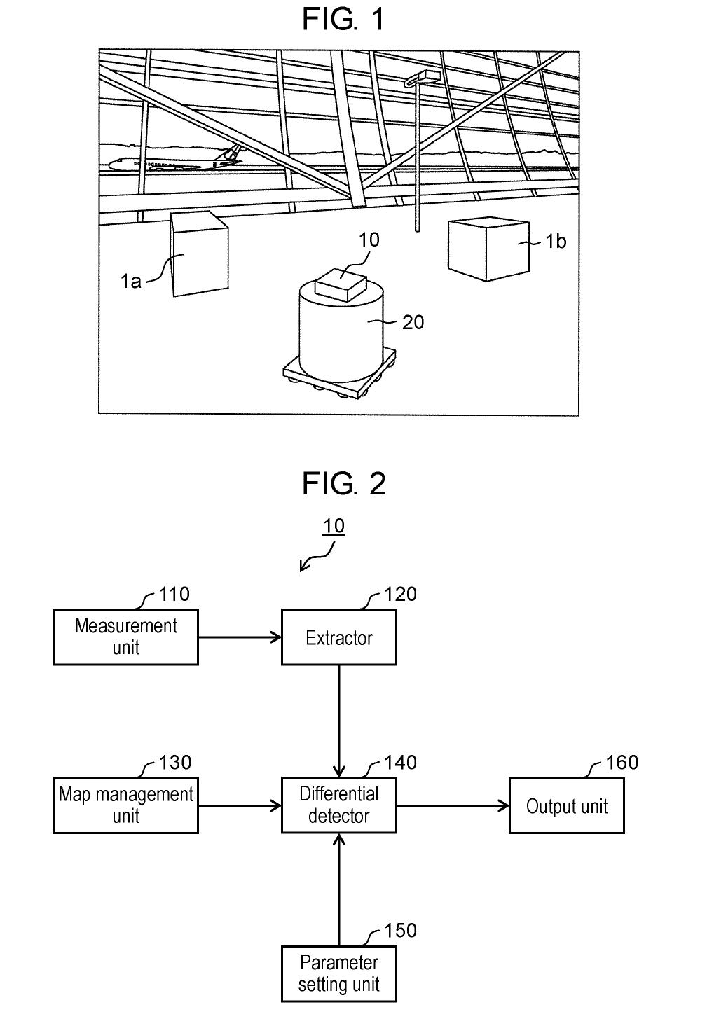

Differential detection device 10 for detecting a spatial difference in its surrounding space is described with reference to FIG. 1 to FIG. 14.

1-1. Configuration

FIG. 1 is a schematic perspective view of a scene of using differential detection device 10.

As shown in FIG. 1, differential detection device 10 is mounted on moving object 20, such as a moving robot, for detecting a spatial difference in its surrounding space. Difference detection device 10 moves in line with movement of moving object 20 in a space where object 1a and object 1b exist.

Differential detection device 10 includes a computer having a memory, processor, and communication interface. Differential detection device 10 achieves a range of functions by executing programs stored in a memory with the processor.

FIG. 2 is a block diagram illustrating a functional configuration of differential detection device 10.

As shown in FIG. 2, differential detection device 10 includes measurement unit 110, extractor 120, map management unit 130, differential detector 140, parameter setting unit 150, and output unit 160.

[1-1-1. Measurement Unit 110]

Measurement unit 110 measures a position of each of multiple points (i.e., measured points) in a surrounding local space, and obtains measured point data that is a result of measurement.

Measurement unit 110 includes, for example, a ranging device, and a processor that executes a program stored in a memory controls the ranging device.

Here, as an example, measurement unit 110 includes a stereo camera and a depth sensor as the ranging device.

The stereo camera is a camera that measures a distance to a target in units of pixel by simultaneously capturing the target from multiple different directions.

The depth sensor is a sensor that measures a distance to a target by measuring time (TOF: Time Of Flight) until receiving a reflected light after irradiating a laser beam, such as infrared rays, to the target.

For example, measurement unit 110 may use the stereo camera or the depth sensor as the ranging device, depending on an operation mode of differential detection device 10.

In addition, for example, measurement unit 110 may perform the above measurement in a certain cycle.

[1-1-2. Extractor 120]

Extractor 120 extracts attribute information on each of voxels that are three-dimensionally arranged in a voxel group and associated with the surrounding local space of measurement unit 110.

Extractor 120 is achieved, for example, by a processor that executes a program stored in a memory.

Measured point data obtained by measuring the local space includes a position expressed with coordinates in a 3D coordinate system specified by measurement unit 110. From measured point data of measured points, extractor 120 extracts data of each voxel (voxel data) in the voxel group in which a local space is segmented into cuboid voxels on a three-dimensional coordinate grid. The voxel data includes position information in the three-dimensional coordinate system. The voxel data extracted from the measured point data by extractor 120 is called measured voxel data, and a voxel that will have the measured voxel data is called a measured voxel.

When extractor 120 extracts (extraction processing) the measured voxel data of the measured voxel, the measured voxel data of the measured voxel is calculated from a measured point data group of multiple measured points in the measured voxel in a way such that information volume is compressed. The information volume is compressed as a measure against a problem of a difficulty to estimate a real-time position due to increased calculation volume for comparing uncompressed measured points because the information volume increases in a three-dimensional space, compared to a two-dimensional plane.

For example, extractor 120 extracts the measured voxel data by obtaining position information on the measured voxel, which is a mean value of positions of points in the measured voxel measured by measurement unit 110. In other words, extractor 120 averages positions in measured point data (positions represented by three-dimensional coordinates X, Y, and Z) of measured points contained in the measured voxel, and calculates the position information on the measured voxel in the measured voxel data.

Still more, extractor 120 extracts the measured voxel data, for example, by calculating a 3×3 covariance matrix of points in each measured voxel. In other words, extractor 120 calculates 3D covariance based on position in the measured point data (position represented by three-dimensional coordinates X, Y, and Z) of each measured point contained in the measured voxel.

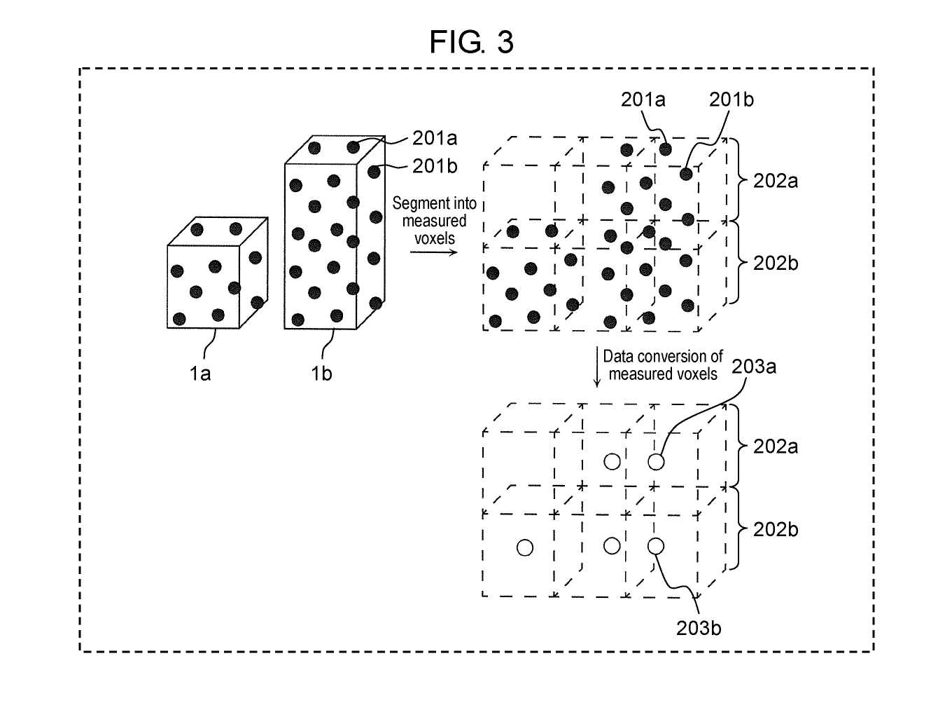

FIG. 3 is a conceptual diagram of a process of extracting the measured voxel data of measured voxels based on measured point data of measured points in the space. In FIG. 3, each piece of measured point data (measured point data 201a, etc.) is indicated at a position associated with a position of its measured point. The measured voxel data (measured voxel data 203a, etc.) of the measured voxel is indicated at a position associated with a position indicated by position information in its measured voxel data. Measurement unit 110 performs measurement in the local space that is a part of a space around moving object 20, and obtains measured point data 201a, 201b or the like of measured points including object 1a and object 1b.

Extractor 120 segments the local space, which is a measurement range, into voxels (e.g., a cube several meters on each side), such as measured voxels 202a and 202b. (In other words, the local space is associated with each of voxels that are three-dimensionally arranged in the voxel group.) Measured voxel 202a has measured voxel data 203a, and measured voxel 202b has measured voxel data 203b. Measured point data 201a, 201b, and so on corresponding to measured points in measured voxel 202a are reflected on measured voxel data 203a of measured voxel 202a.

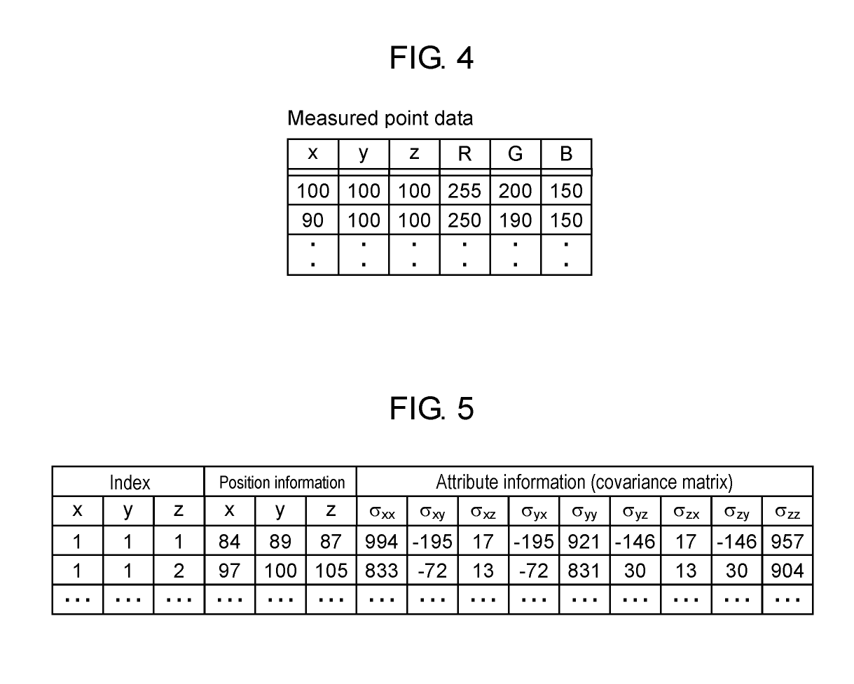

As shown in FIG. 4, the measured point data indicates a position defined by three-dimensional coordinates X, Y, and Z, and a color in that position is defined by RGB values. FIG. 4 shows measured point data of one measured point in each line.

FIG. 5 is an example of the measured voxel data. Each line shows the measured voxel data of one measured voxel. The measured voxel data shown in FIG. 5 is temporarily stored in a storage medium, such as a memory. As shown in FIG. 5, the measured voxel data includes an index that shows a position of an applicable measured voxel in three-dimensionally arranged measured voxels in the measured voxel group associated with the local space, position information indicating a mean value of positions in the measured point data in the measured voxel, and covariance matrix that is attribute information on the measured voxel. For example, in measured voxel data 203a in FIG. 3, the position information in measured voxel data 203a in FIG. 3 is a mean value of positions indicated in measured point data (measured point data 201a, 201b, etc.) corresponding to measured points in measured voxel 202a, and the attribute information in measured voxel data 203a is 3×3 covariance matrix of the measured point group in measured voxel 202a.

[1-1-3. Map Management Unit 130]

Map management unit 130 has a function to manage voxel data, i.e., position information and attribute information (more particularly, covariance matrix), of each of voxels that are three-dimensionally arranged in a voxel group and associated with the space shown on a map (i.e., a map specifying 3D coordinate system for representing the space). For example, map management unit 130 is achieved by a processor executing a program stored in a memory.

Map management unit 130 may also have a function to manage voxel data of multiple voxel groups with different voxel sizes from each other.

The voxel data managed by map management unit 130 is called map voxel data, and a voxel that will have the map voxel data is called a map voxel. In some cases, the measured voxel and the map voxel are collectively called voxel, and the measured voxel data and the map voxel data are collectively called voxel data. Map management unit 130 manages map information including the map voxel data (position information and attribute information) of each map voxel in the map voxel group generated by segmenting the space.

Map management unit 130 manages map information to provide available map information. More specifically, the map information is stored in a recording medium, such as a memory. Alternatively, the map information is obtained typically from an external device. The map information is, for example, information generated in advance by measuring a space in accordance with predetermined 3D coordinate system. For example, a position of each measured point in the space is measured, and then the map information is generated by extracting map voxel data (position information and attribute information) of each map voxel based on the measurement result. The map voxel data may be extracted based on this measurement result by typically using the same method as that in extractor 120 for extracting the measured voxel data of measured voxel from measured point data.

In the exemplary embodiment, a data structure of map voxel data is same as the measured voxel data shown in FIG. 5. In other words, the map voxel data includes an index indicating a position of the map voxel, position information indicating a mean value of results of measured positions of points (i.e., locations) in a part of the space corresponding to the map voxel, and attribute information indicating covariance matrix of each point (i.e., each location) in a part of the space corresponding to the map voxel.

[1-1-4. Differential Detector 140]

Differential detector 140 uses a parameter set by parameter setting unit 150, which is described later, to detect presence or absence of a difference between the attribute information on each measured voxel and attribute information on a map voxel at a position corresponding to each measured voxel.

For example, differential detector 140 is achieved by a processor that executes a program stored in a memory.

On detecting aforementioned presence or absence of a difference, differential detector 140 may, for example, detect presence of a difference when a map voxel at a position corresponding to a measured voxel having significant attribute information does not have significant attribute information. This enables differential detection device 10 to detect the presence or the absence of the difference with relatively low throughput.

Still more, on detecting aforementioned presence or absence of a difference, differential detector 140 may, for example, detect presence of a difference only when a map voxel at a position adjacent to the position corresponding to the measured voxel having significant attribute information also does not have significant attribute information. This enables differential detection device 10 to further accurately detect the presence or the absence of the difference.

Still more, on detecting aforementioned presence or absence of a difference, differential detector 140 may, for example, detect presence of a difference when the map voxel at the position corresponding to the measured voxel having attribute information (covariance matrix) indicating a shape type has attribute information (covariance matrix) indicating a shape type, but the shape type indicated by the attribute information on the measured voxel and the shape type indicated by the attribute information on the map voxel differ. This enables differential detection device 10 to further accurately detect the presence or the absence of the difference.

Still more, on detecting aforementioned presence or absence of a difference, differential detector 140 may, for example, detect presence of a difference when the map voxel at the position corresponding to the measured voxel having attribute information (covariance matrix) indicating a normal direction of a plane or line segment has attribute information (covariance matric) indicating a normal direction of a plane or line segment, but a similarity of the normal direction indicated by the attribute information on the measured voxel and the normal direction indicated by the attribute information on the map voxel is lower than a predetermined value. This enables differential detection device 10 to further accurately detect the presence or the absence of the difference.

Still more, for example, measurement unit 110 measures a position of each of multiple points in a surrounding local space for the N times (N is a whole number not less than 2), and extractor 120 extracts the attribute information on each measured voxel after every measurement by measurement unit 110. In this case, differential detector 140 makes voting on aforementioned presence or absence of a difference, after every extraction as described above by extractor 120, to make a positive vote for presence of a difference when the map voxel at the position corresponding to the measured voxel having significant attribute information does not have significant attribute information. After voting is repeated for the N times, differential detector 140 may determine aforementioned presence or absence of a difference based on a result of voting for the N times. This enables differential detection device 10 to detect the presence or the absence of the difference while being moved together with moving object 20 in which differential detection device 10 is installed.

Alternatively, in the above voting, for example, differential detector 140 may make a positive vote for presence of a difference only when a map voxel at a position adjacent to the position corresponding to the target measured voxel also does not have significant attribute information. This enables differential detection device 10 to further accurately detect the presence or the absence of the difference while moving together with moving object 20 in which differential detection device 10 is installed.

Still more, for example, measurement unit 110 measures a position of each of multiple points in a surrounding local space for the N times (N is a whole number not less than 2), and extractor 120 extracts the attribute information on each measured voxel after every measurement by measurement unit 110. In this case, differential detector 140 makes voting on aforementioned presence or absence of a difference, after every extraction as described above by extractor 120, to make a positive vote for presence of a difference when the map voxel at the position corresponding to the measured voxel having attribute information (covariance matrix) indicating a shape type has attribute information (covariance matrix) indicating a shape type, but the shape type indicated in the attribute information on the measured voxel and the shape type indicated in the attribute information on the map voxel differ. After voting is repeated for the N times, differential detector 140 may determine aforementioned presence or absence of a difference based on a result of voting for the N times. This enables differential detection device 10 to further accurately detect the presence or the absence of the difference while being moved together with moving object 20 in which differential detection device 10 is installed.

Still more, for example, measurement unit 110 measures a position of each of multiple points in a surrounding local space for the N times (N is a whole number not less than 2), and extractor 120 extracts the attribute information on each measured voxel after every measurement by measurement unit 110. In this case, differential detector 140 makes voting on aforementioned presence or absence of a difference, after every extraction as described above by extractor 120, to make a positive vote for presence of a difference when the map voxel at the position corresponding to the measured voxel having attribute information (covariance matrix) indicating a normal direction of a plane or line segment has attribute information (covariance matric) indicating a normal direction of a plane or line segment, but a similarity between the normal direction indicated in the attribute information on the measured voxel and the normal direction indicated in the attribute information on the map voxel is lower than a predetermined value. After voting is repeated for the N times, differential detector 140 may determine aforementioned presence or absence of a difference based on a result of voting for the N times. This enables differential detection device 10 to further accurately detect the presence or the absence of the difference while being moved together with moving object 20 in which deferential detection device 10 is installed.

[1-1-5. Parameter Setting Unit 150]

Parameter setting unit 150 sets a numeric value to one or more parameters according to an operation mode of differential detection device 10 set by the user of differential detection device 10.

For example, parameter setting unit 150 includes an input interface for receiving setting of the operation mode of differential detection device 10 by the user, and a processor that executes a program stored in a memory controls the input interface.

The input interface is typically a key board, mouse, touch panel, or push-button switch.

A parameter to which a numeric value is set by parameter setting unit 150 may be a voting threshold that differential detector 140 uses for determining the presence or the absence of the difference based on the voting results.

[1-1-6. Output Unit 160]

Output unit 160 outputs a detection result of differential detector 140.

For example, output unit 160 includes an output interface for outputting a display result to the user, and a processor that executes a program stored in a memory controls the output interface.

The output interface is typically an output port, display, or loudspeaker.

When an external display device exists, output unit 160 may output an image representing the detection result to display the result on that display device. This enables differential detection device 10 to notify the user of the detection result using an image.

The operation of differential detection device 10 as configured above is described below with reference to drawings.

[1-2. Operation]

[1-2-1. Operation of the Extractor]

A characteristic operation of extractor 120 is extraction of the measured voxel data.

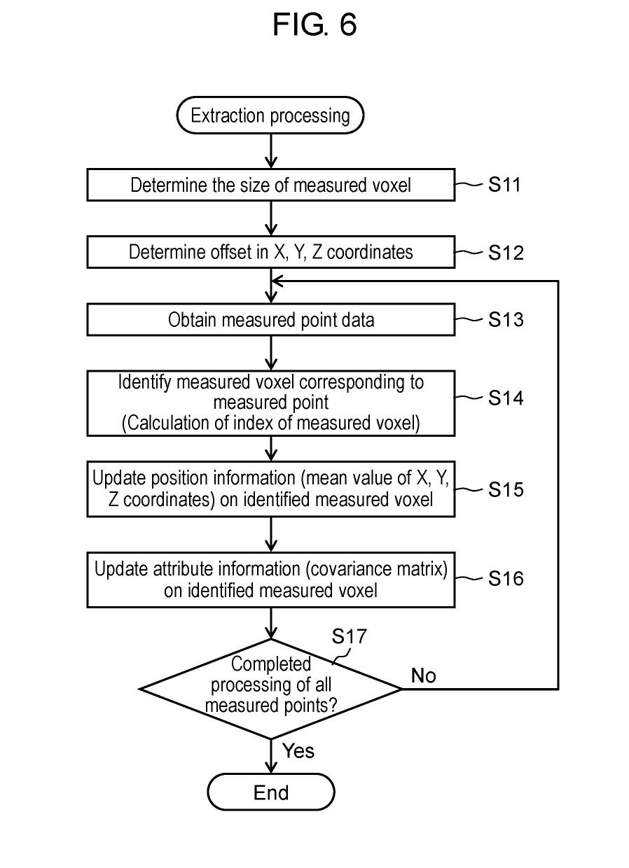

FIG. 6 is a flow chart illustrating an example of extraction processing. The extraction processing is described with reference to FIG. 6.

The extraction processing starts, for example, when the user using differential detection device 10 operates differential detection device 10 to start the extraction processing.

When the extraction processing starts, extractor 120 determines a voxel size of a measured voxel (Step S11). For example, length in X, Y, and Z directions in the 3D coordinate system (3D XYZ coordinate system) for measurement is specified as the voxel size. The voxel size is, for example, set to a cube 1 m on each side. Extractor 120 also determines offset X, Y, and Z coordinates that are additional values used for converting values (X, Y, Z coordinate values) in a measuring range in the 3D coordinate system related to measurement of measured voxels to indexes. The voxel size of measured voxel does not necessarily be the same as a voxel size of the map voxel.

Next, extractor 120 obtains measured point data of one point in measured points corresponding to the surrounding local space that are measured by measurement unit 110 (Step S13). A measured voxel corresponding to the obtained measured point data (a measured voxel including a position related to the measured point data) is identified to calculate an index of the measured voxel (Step S14). For example, the index of measured voxel is calculated based on the following formulae 1 to 3 using coordinate values of the measured point data. This index is a number indicating a position in three-dimensional arrangement of each measured voxel that is three-dimensionally arranged in the measured voxel group in the local space.

X (index)=(X coordinate of measured point+X coordinate of offset)/Voxel size (Formula 1)

Y (index)=(Y coordinate of measured point+Y coordinate of offset)/Voxel size (Formula 2)

Z (index)=(Z coordinate of measured point+Z coordinate of offset)/Voxel size (Formula 3)

Next, extractor 120 uses a position in the measured point data obtained in Step S13 for updating the position information (a mean value of X, Y, and Z coordinates) on the measured voxel identified in Step S14 (Step S15). Extractor 120 also uses the position in the measured point data obtained in Step S13 for calculating 3D covariance to update the attribute information on the measured voxel identified in Step S14 (Step S16). Through these Step S15 and Step S16, the measured voxel data (position information and attribute information) shown in FIG. 5, which is provisionally retained in a storage medium such as a memory, is updated. Then, each piece of unprocessed measured point data is sequentially processed by repeating Steps S13 to S16 until all pieces of measured point data are processed (Step S17).

This extraction processing (Steps S11 to S17) or a part of the processing, Steps S13 to S17, may be executed every time measurement unit 110 obtains a measured point data group of measured points in the surrounding local space (e.g., measured points for the entire circumference in the horizontal direction). When extractor 120 extracts measured voxel data (position information and attribute information) of each measured voxel after a certain volume of the measured point data group is collected, as described above, a mean value of positions in measured point data of measured points located in each measured voxel may be used as the position information of the measured voxel, and 3D covariance in the measured point data may be used as the attribute information. A position of measured voxel (e.g., X, Y, and Z coordinates of one vertex at the smallest position in the measured voxel) can be identified using Formula 4 to Formula 6 below based on the index.

X coordinate of measured voxel=X (index)×Voxel size−X coordinate of offset (Formula 4)

Y coordinate of measured voxel=Y (index)×Voxel size−Y coordinate of offset (Formula 5)

Z coordinate of measured voxel=Z (index)×Voxel size−Z coordinate of offset (Formula 6)

[1-2-2. Operation of Differential Detector]

Differential detector 140 executes differential detection processing for detecting the presence or the absence of the difference between attribute information on each measured voxel and attribute information on a map voxel at a position corresponding to each measured voxel.

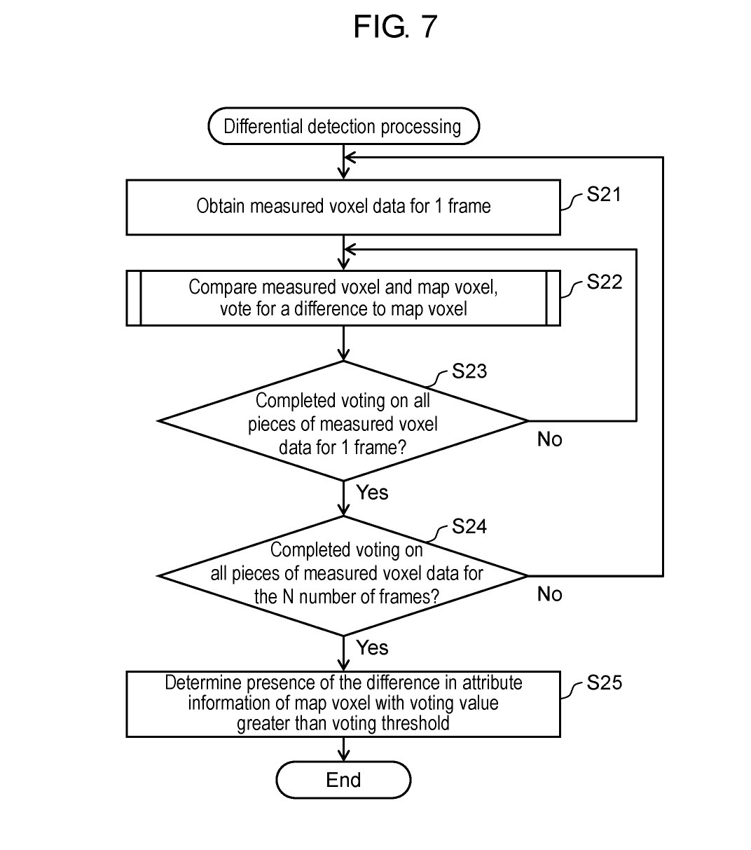

FIG. 7 is a flow chart illustrating an example of the differential detection processing by differential detector 140. The differential detection processing is described with reference to FIG. 7.

Here, the differential detection processing is described with precondition that measurement unit 110 obtains measured point data at a predetermined frame rate, and extractor 120 extracts the attribute information on each measured voxel at the predetermined frame rate.

For example, the differential detection processing is started when extractor 120 extracts the attribute information for a predetermined number of times (e.g., N (N is a whole number not less than 2)).

When the differential detection processing starts, differential detector 140 obtains measured voxel data for one frame that is not yet selected in measured voxel data for the N number of frames extracted by extractor 120 (Step S21).

With respect to the measured voxel data that is not yet selected in measured voxel data for one frame, differential detector 140 compares a measured voxel of the measured voxel data and map voxels at positions same and close to the measured voxel, and executes voting processing for a difference to the map voxel (Step S22).

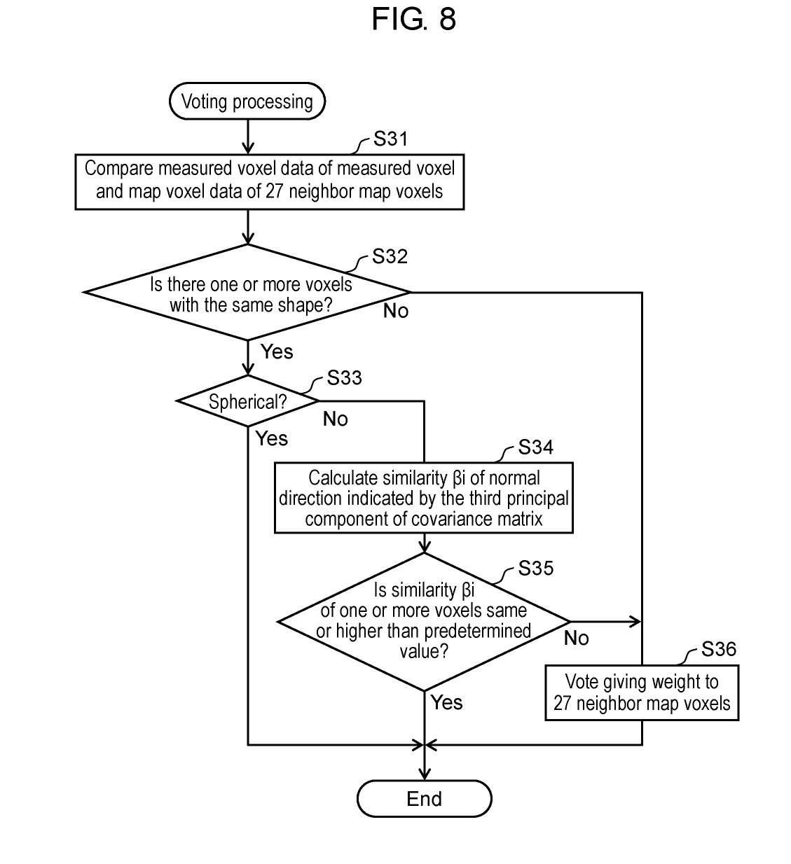

FIG. 8 is a flow chart illustrating an example of the voting processing by differential detector 140. The voting processing is detailed with reference to FIG. 8.

When voting starts, differential detector 140 compares measured voxel data of a target measured voxel with map voxel data including 27 map voxels consisted of a map voxel with the same index as the target measured voxel and 26 map voxels adjacent to this map voxel (hereinafter also referred to as “27 neighbor map voxels”) (Step S31).

In Step S31, differential detector 140 first reads out the map voxel data of the 27 adjacent map voxels. Then, differential detector 140 classifies the measured voxel data of the target measured voxel and the map voxel data of the 27 neighbor map voxels into spherical shape (λ3≈λ2≈λ1>>0), sheet shape (λ3≈λ2>>λ1≈0), and linear shape (λ3>>λ2≈λ1≈0), using eigenvalues λ1, λ2, and λ3 (λ1+λ2+λ3=1, λ3>λ2>λ1) of covariance matrix. Then, classified shapes are compared.

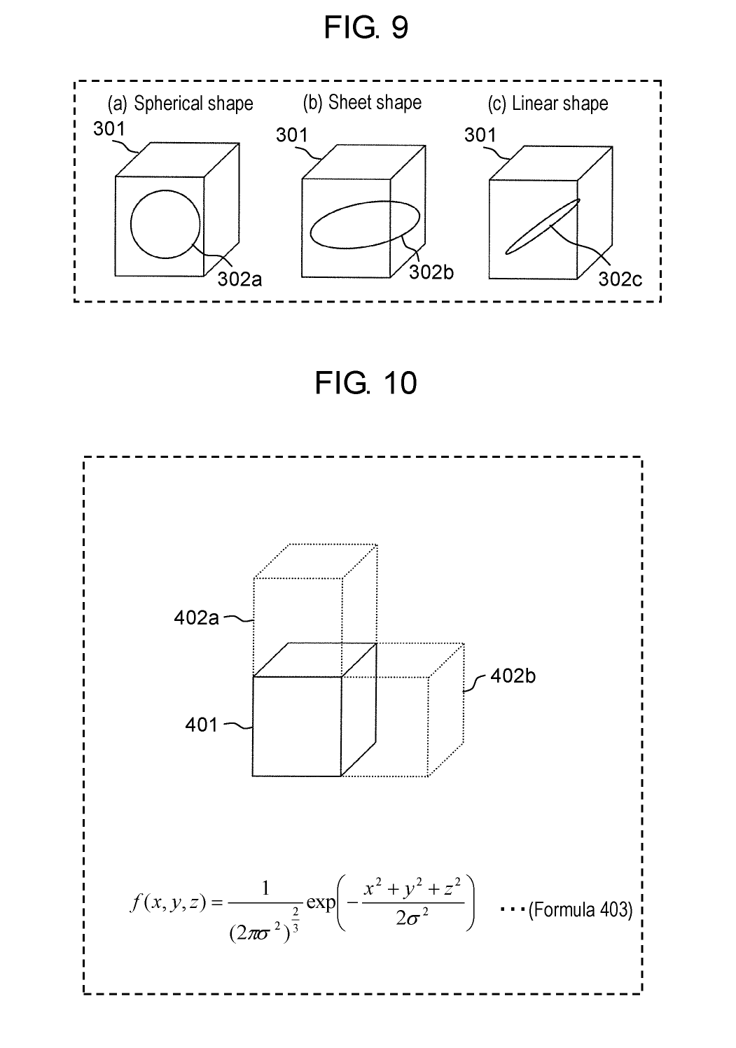

FIG. 9 shows voxel data classified into spherical, sheet, and linear shape. An example shown in FIG. 9 conceptually illustrates classification of voxel data 302a, 302b, and 302c of voxel 301 into spherical shape ((a) in FIG. 9), sheet shape ((b) in FIG. 9), and linear shape ((c) in FIG. 9).

Here, map voxels may overlap. Overlapping means that a part of voxel is overlapped with another voxel. For example, voxels are positioned such that they overlap each other for a half voxel. Also, the map voxel group managed by map management unit 130 may be overlapped. For example, at least some of the map voxel group consisted of the plurality of map voxels may overlap with another map voxel group. In this case, one or more map voxels in the plurality of map voxels may be included in both the map voxel group and another map voxel group. Overlapping is effective for reducing positional deviation between the map point group and the measured point group or error due to deviation in positional estimation and sensor's ranging error. This enables differential detection device 10 to further accurately detect the presence or the absence of the difference while moving.

After Step S31, differential detector 140 determines whether or not the same shape as the shape indicated in the measured voxel data of the target measured voxel is found in one or more pieces of the map voxel data of the 27 adjacent map voxels (Step S32).

When the same shape is not found in one or more in Step S32 (Step S32: No), differential detector 140 gives weight on the 27 neighbor map voxels to make a positive vote for presence of a difference (Step S36), and ends the voting processing.

FIG. 10 gives an example of giving weight to target measured voxel 401 and neighbor map voxels 402a and 402b on a positive voting for presence of a difference.

For example, differential detector 140 may calculate weight f (x, y, z) related to a distance of index in x, y, and z directions, based on the target measured voxel, by using average 0 and three-dimensional normal distribution formula of variance σ, as shown by formula 403 in FIG. 10.

In Step S32 in FIG. 8, when the same shape is determined to exist in one or more of the 27 neighbor map voxels (Step S32: Yes), differential detector 140 checks whether or not the shape is spherical (Step S33).

In Step S33, when the shape is spherical (Step S33: Yes), differential detector 140 ends the voting processing without voting.

In Step S33, when the shape is not spherical (Step S33: No), i.e., the shape is sheet or linear, differential detector 140 calculates similarity 8i in the normal direction of the third principal component of covariance matrix (Step S34).

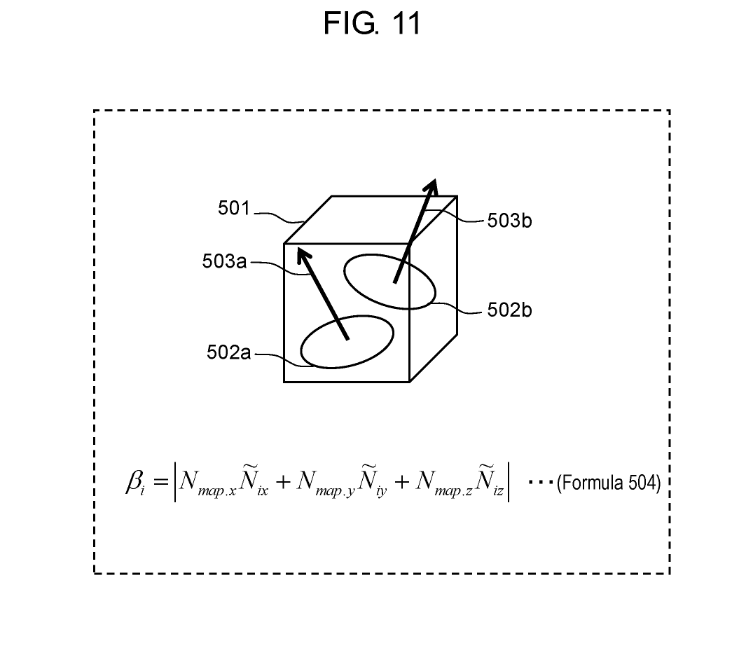

FIG. 11 gives an example of calculation of similarity 8i in the normal direction.

For example, as shown in FIG. 11, differential detector 140 may calculate similarity ßi expressed by Formula 504, based on normal direction vectors Nmap=(Nmap.x, Nmap.y, Nmap.z) and Ni=(Nix, Niy, Niz) of normal 503a and normal 503b relative to main faces configured with the first principal component and the second principal component when the principal components of covariance matrix are analyzed in measured voxel data 502a and map voxel data 502b corresponding to voxel 501.

After similarity 8i in the normal direction is calculated in Step S34 of FIG. 8, differential detector 140 determines whether or not similarity 8i is not less than a predetermined value (i.e., high similarity) in one or more map voxels (Step S35).

In Step S35, when a map voxel with high similarity is found (Step S35: Yes), differential detector 140 ends the voting processing without voting.

In step S35, when no map voxel with high similarity is found (Step S35: No), differential detector 140 gives weight on the 27 neighbor map voxels to make a positive vote for presence of a difference (Step S36), and ends the voting processing.

When the voting processing (Step S22) ends in FIG. 7, differential detector 140 determines whether or not the voting processing for all pieces of measured voxel data in one frame has completed (Step S23).

In Step S23, when the voting processing for all pieces of measured voxel data in one frame has not yet completed (Step S23: No), differential detector 140 returns to Step S22 again, and repeats on and after Step S22 again until the voting processing for all pieces of measured voxel data for one frame is completed.

In Step S23, when the voting processing for all pieces of measured voxel data for one frame is completed (Step S23: Yes), differential detector 140 determines whether or not the voting processing for all pieces of measured voxel data for the N number of frames has completed (Step S24).

In Step S24, when the voting processing for all pieces of measured voxel data for the N number of frames has not yet completed (Step S24: No), differential detector 140 returns to Step S21 again and repeats on and after Step S21 until the voting processing for all pieces of measured voxel data for the N number of frames is completed.

In Step S24, when the voting processing for all pieces of measured voxel data for the N number of frames is completed (Step S24: Yes), differential detector 140 identifies a map voxel that has a voting value greater than a voting threshold, which is a numeric value in a parameter set by parameter setting unit 150, in the map voxels. Differential detector 140 then determines that the attribute information has presence of a difference between the identified map voxel and corresponding measured voxel (Step S25).

[1-2-3. Operation of Parameter Setting Unit]

Parameter setting unit 150, for example, stores in advance a parameter setting table that relates an operation mode of differential detection device 10 to a numeric value to be set to the parameter. With reference to the stored parameter setting table, parameter setting unit 150 executes setting processing for setting a numeric value to the parameter, together with differential detector 140.

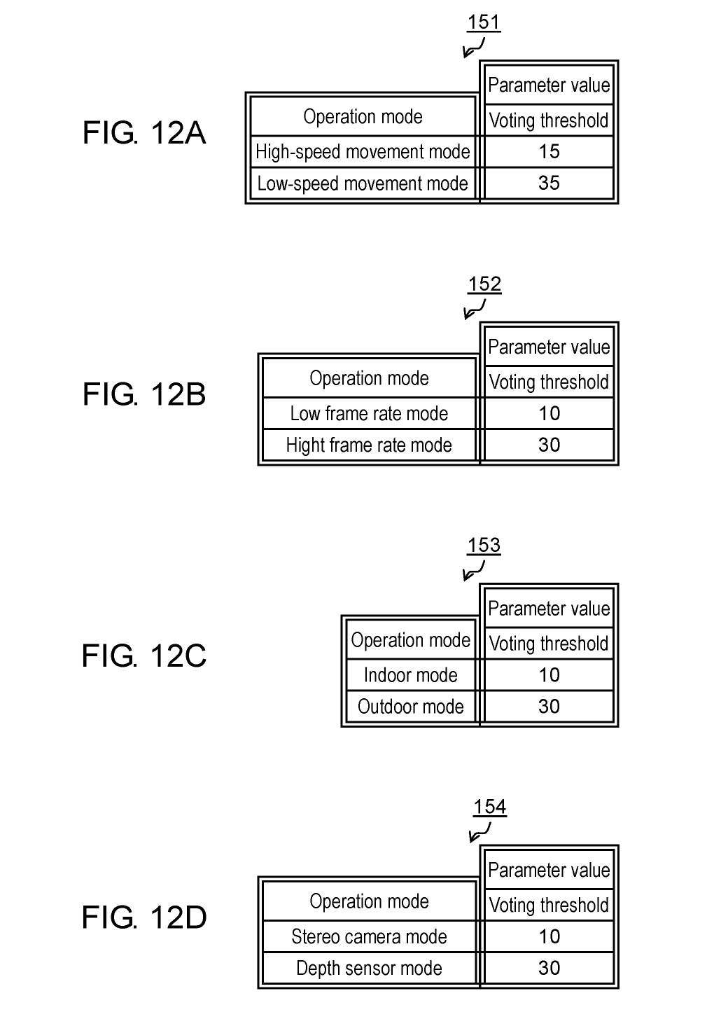

FIG. 12A shows a data structure of parameter setting table 151 set according to operation modes with different moving speeds. As shown in FIG. 12A, parameter setting table 151 relates an operation mode of differential detection device 10 and a parameter value (numeric value) set to a voting threshold (parameter).

In this example, the operation mode of differential detection device 10 includes a high-speed movement mode (an example of the first mode) that has a relatively high speed (e.g., 7 km/hr) as the moving speed of moving object 20 in which differential detection device 10 is installed (in other words, the moving speed of differential detection device 10), and a low-speed movement mode (an example of the second mode) that has a relatively low speed (e.g., 3 km/hr) as the moving speed of differential detection device 10. A relatively low voting threshold of “15” is given to the high-speed movement mode, and relatively high voting threshold of “35” is given to the low-speed movement mode.

Parameter setting unit 150 refers to stored parameter setting table 151, and sets “15” to the voting threshold when the operation mode input by the user is the high-speed movement mode. When the operation mode input by the user is the low-speed movement mode, parameter setting unit 150 sets “35” to the voting threshold.

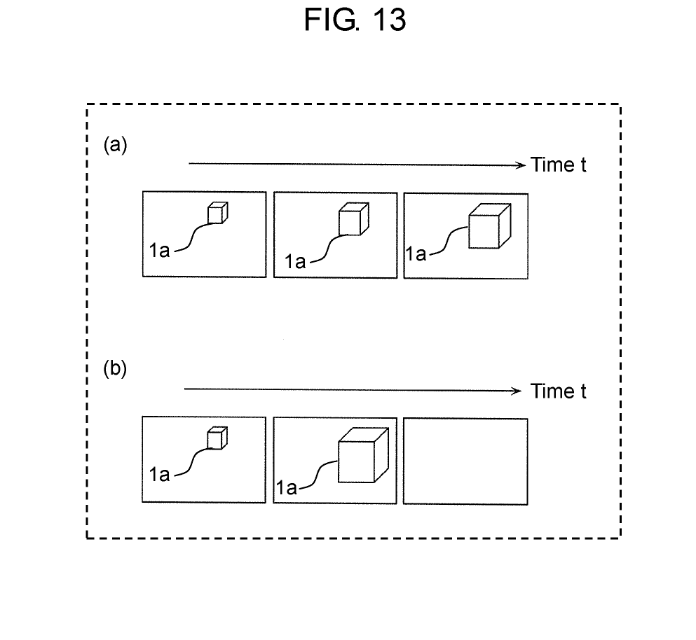

FIG. 13 is a conceptual diagram illustrating a change of the number of measurements of object 1a (see FIG. 1) and the number of votes, depending on the moving speed of differential detection device 10.

As shown in FIG. 13, when the moving speed of differential detection device 10 is relatively high ((b) in FIG. 13), the number of votes with respect to object 1a becomes relatively small. This makes a voting value for object 1a relatively low. Accordingly, the voting threshold is set relatively low when the moving speed of differential detection device 10 is relatively high.

On the other hand, when the moving speed of differential detection device 10 is relatively low ((a) in FIG. 13), the number of votes with respect to object 1a becomes relatively large. This makes a voting value for object 1a relatively high. Accordingly, the voting threshold is set relatively high when the moving speed of differential detection device 10 is relatively low.

FIG. 12B shows a data structure of parameter setting table 152 that is set according to operation modes with different measurement cycles. In the example, the operation modes of differential detection device 10 include a low frame rate mode (an example of the first mode) whose frame rate for obtaining measurement point data by measurement unit 110 is relatively low (e.g., 20 fps), and a high frame rate mode (an example of the second mode) whose frame rate for obtaining measurement point data by measurement unit 110 is relatively high (e.g., 60 fps). A relatively low voting threshold of “10” is given to the low frame rate mode, and a relatively high voting threshold of “30” is given to the high frame rate mode.

Parameter setting unit 150 refers to stored parameter setting table 152 and sets “10” to the voting threshold when the operation mode input by the user is the low frame rate mode. When the operation mode input by the user is the high frame rate mode, “30” is set to the voting threshold.

When the frame rate for obtaining measured point data by measurement unit 110 is relatively low, the number of votes with respect to object 1a becomes relatively small. This makes a voting value for object 1a relatively low. Accordingly, the voting threshold is set relatively low when the frame rate for obtaining measured point data by measurement unit 110 is relatively low.

On the other hand, when the frame rate for obtaining measured point data by measurement unit 110 is relatively high, the number of votes with respect to object 1a becomes relatively large. This makes a voting value for object 1a relatively high. Accordingly, the voting threshold is set relatively high when the frame rate for obtaining measured point data by measurement unit 110 is relatively high.

FIG. 12C shows a data structure of parameter setting table 153 set according to operation modes with different usage places.

In the example, the operation modes of differential detection device 10 include an indoor mode for use of differential detection device 10 indoors (an example of the first mode), and an outdoor mode for use of differential detection device 10 outdoors (an example of the second mode). A relatively low voting threshold of “10” is given to the indoor mode, and a relatively high voting threshold of “30” is given to the outdoor mode.

Parameter setting unit 150 refers to stored parameter setting table 153, and sets “10” to the voting threshold when the operation mode input by the user is the indoor mode. When the operation mode input by the user is the outdoor mode, “30” is set to the voting threshold.

When measurement unit 110 uses the stereo camera as a ranging device, the quantity of measurement point data group to be obtained changes in line with the quantity of textures of an object, due to the nature of the stereo camera.

In general, when differential detection device 10 is used indoors, a homogeneous wall or floor tends to be often contained in the object, and thus the amount of measured point data group obtained by measurement unit 110 using the stereo camera tends to become relatively small. Accordingly, the voting threshold is set relatively low when differential detection device 10 is used indoors.

On the other hand, when differential detection device 10 is used outdoors, the object tends to be diverse, in general, and thus the amount of measurement point data group obtained by measurement unit 110 using the stereo camera tends to become relatively large. Accordingly, a voting threshold is set relatively high when differential detection device 10 is used outdoors.

FIG. 12D shows a data structure of parameter setting table 154 set according to operation modes with different ranging devices.

In this example, when differential detection device 10 is used indoors, the operation modes of differential detection device 10 include a stereo camera mode (an example of the first mode) in which measurement unit 110 uses the stereo camera (an example of the first sensor) as the ranging device in indoor use, and a depth sensor mode (an example of the second mode) in which measurement unit 110 uses the depth sensor (an example of the second sensor) as the ranging device in indoor use. A relatively low voting threshold of “10” is given to the stereo camera mode for indoor use, and a relatively high threshold of “30” is given to the depth sensor mode for indoor use.

Parameter setting unit 150 refers to stored parameter setting table 154, sets “10” to the voting threshold when the operation mode input by the user is the stereo camera mode for indoor use, and sets “30” to the voting threshold when the operation mode input by the user is the depth sensor mode for indoor use.

In general, when differential detection device 10 is used indoors and measurement unit 110 uses the stereo camera as the ranging device, the amount of measured point data group obtained by measurement unit 110 tends to become relatively small, as described above. Accordingly, a relatively low voting threshold is set when measurement unit 110 uses the stereo camera as the ranging device.

On the other hand, when differential detection device 10 is used indoors and measurement unit 110 uses the depth sensor as the ranging device, the amount of measured point data group obtained by measurement unit 110, in general, tends to be equivalent to the case of using differential detection device 10 outdoors. Accordingly, a relatively high voting threshold is set when measurement unit 110 uses the depth sensor as the ranging device.

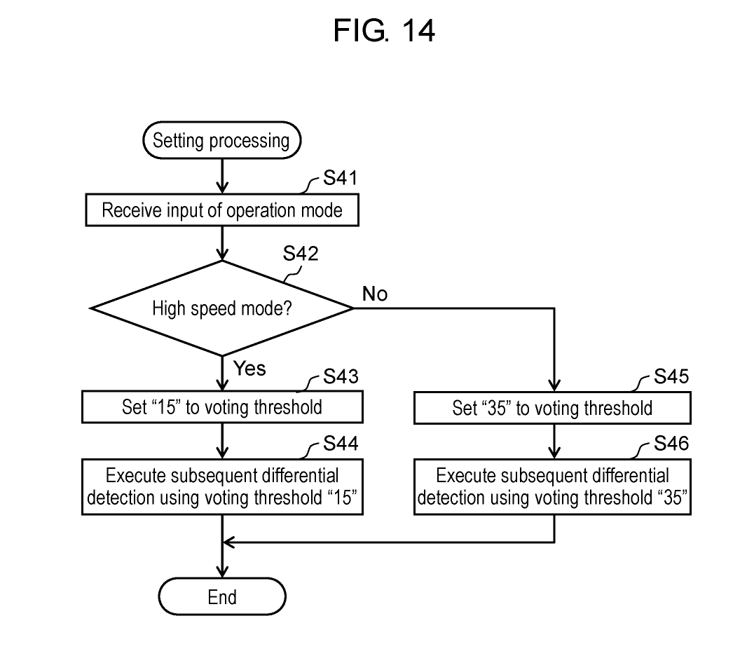

FIG. 14 is a flow chart illustrating an example of setting processing by parameter setting unit 150 and differential detector 140.

The setting processing below refers to the case that the operation modes of differential detection device 10 include the high-speed movement mode and low-speed movement mode, and parameter setting unit 150 stores parameter setting table 151. However, the setting processing is same also when the operation modes include the low frame rate mode and high frame rate mode, and parameter setting unit 150 stores parameter setting table 152. Still more the setting processing is same also when the operation modes include indoor mode and outdoor mode, and parameter setting unit 150 stores parameter setting table 153. Furthermore, the setting processing is also same when the operation modes include the stereo camera mode and depth sensor mode, and parameter setting unit 150 stores parameter setting table 154.

For example, the setting processing starts when the user using differential detection device 10 operates differential detection device 10 to start the setting processing.

When the setting processing starts, parameter setting unit 150 receives the operation mode of differential detection device 10 input by the user of differential detection device 10 (Step S41). Parameter setting unit 150 then determines whether the received operation mode is the high-speed movement mode or not, i.e., the high-speed movement mode or low-speed movement mode (Step S42).

In Step S42, when the received operation mode is the high-speed movement mode (Step S42: Yes), parameter setting unit 150 refers to stored parameter setting table 151, and sets “15” to the voting threshold (Step S43). Then, differential detector 140 executes subsequent differential detection processing based on voting threshold “15” (Step S44).

In Step S42, when the received operation mode is the low-speed movement mode (Step S42: No), parameter setting unit 150 refers to stored parameter setting table 151, and sets “35” to the voting threshold (Step S45). Then, differential detector 140 executes subsequent differential detection processing based on voting threshold “35” (Step S46).

[1-4. Effects]

In differential detection device 10, for example, the operation modes include the high-speed movement mode and low-speed movement mode that correspond to different moving speeds of a moving object. Parameter setting unit 150 sets different numeric values to the parameter for the high-speed movement mode and the low-speed movement mode that are set by the user as the operation mode. Differential detector 140 detects presence of a difference in detection of the presence or the absence of the difference when a predetermined relation is established between the numeric value set to the parameter by parameter setting unit 150 and a result of the N number of votes. This enables differential detection device 10 to set a different numeric value to the parameter for operation modes with different moving speeds.

Still more, in differential detection device 10, for example, measurement unit 110 executes measurement for the N times in a predetermined cycle, and the operation modes include the low frame rate mode and high frame rate mode with different predetermined cycles. Parameter setting unit 150 sets different numeric values to the parameter for the low frame rate mode and high frame rate mode that are set by the user as the operation mode. Differential detector 140 may detects presence of a difference in detection of the presence or the absence of the difference when a predetermined relation is established between the numeric value set to the parameter by the parameter setting unit and a result of the N number of votes. This enables the differential detector to set different numeric values to the parameter for the operation modes with different measurement cycles.

Still more, the operation modes include, for example, the indoor mode and the outdoor mode according to the place of use of the moving object, and parameter setting unit 150 sets different numeric values to the parameter for the indoor mode and the outdoor mode that are set by the user as the operation mode. Differential detector 140 detects presence of a difference in detection of the presence or the absence of the difference when a predetermined relation is established between the numeric value set to the parameter by parameter setting unit 150 and a result of the N number of votes.

This enables differential detection device 10 to set different numeric values to the parameter for the operation modes depending on the place of use of the moving object.

Still more, measurement unit 110 includes, for example, a stereo camera and a depth sensor as a ranging device that can measure positions, and the operation modes include the stereo camera mode for using measurement results of the stereo camera and the depth sensor mode for using measurement results of the depth sensor. Extractor 120 extracts attribute information from measurement results of the stereo camera when the operation mode set by the user is the stereo camera mode, and extracts attribute information from measurement results of the depth sensor when the operation mode set by the user is the depth sensor mode. Parameter setting unit 150 sets different numeric values to the parameter for the stereo camera mode and the depth sensor mode that are set by the user as the operation mode. Differential detector 140 detects presence of a difference in detection of the presence or the absence of the difference when a predetermined relation is established between the numeric value set to the parameter by parameter setting unit 150 and a result of the N number of votes.

This enables the differential detection device to set different numeric values to the parameter for the operation modes using different ranging devices.

Still more, the stereo camera mode and the depth sensor mode may be set as the operation modes for using the differential detection device indoors. This enables the differential detection device to set different numeric values to the parameter for the operation modes using different ranging devices in the operation mode for indoor use.

Differential detection device 10 as configured above allows the user of differential detection device 10 to set parameters used for differential detection by differential detection device 10 by setting the operation modes to differential detection device 10.

Accordingly, user's bothersome setting of parameters for using differential detection device 10 can be eased, compared to the prior art.

### Second Exemplary Embodiment

Next is described differential detection device 10A in the second exemplary embodiment whose functions are partially changed from that of differential detection device 10 in the first exemplary embodiment.

Differential detection device 10A can change the size of voxel used according to the operation mode set to differential detection device 10A.

Differential detection device 10A is described below, centering on differences with differential detection device 10 in the first exemplary embodiment.

[2-1 Configuration]

Differential detection device 10A has the same hardware configuration as differential detection device 10 in the first exemplary embodiment. However, programs to be executed are partially changed. Therefore, functions achieved by differential detection device 10A are partially changed from the functions achieved by differential detection device 10 in the first exemplary embodiment.

Differential detection device 10A includes a spherical shape detection mode (an example of the third mode) in which the shape of object assumed to be causing detected difference is spherical, and a sheet and linear shape detection mode (an example of the fourth mode) in which the object has sheet or linear shape; in addition to the operation modes of differential detection device 10 in the first exemplary embodiment.

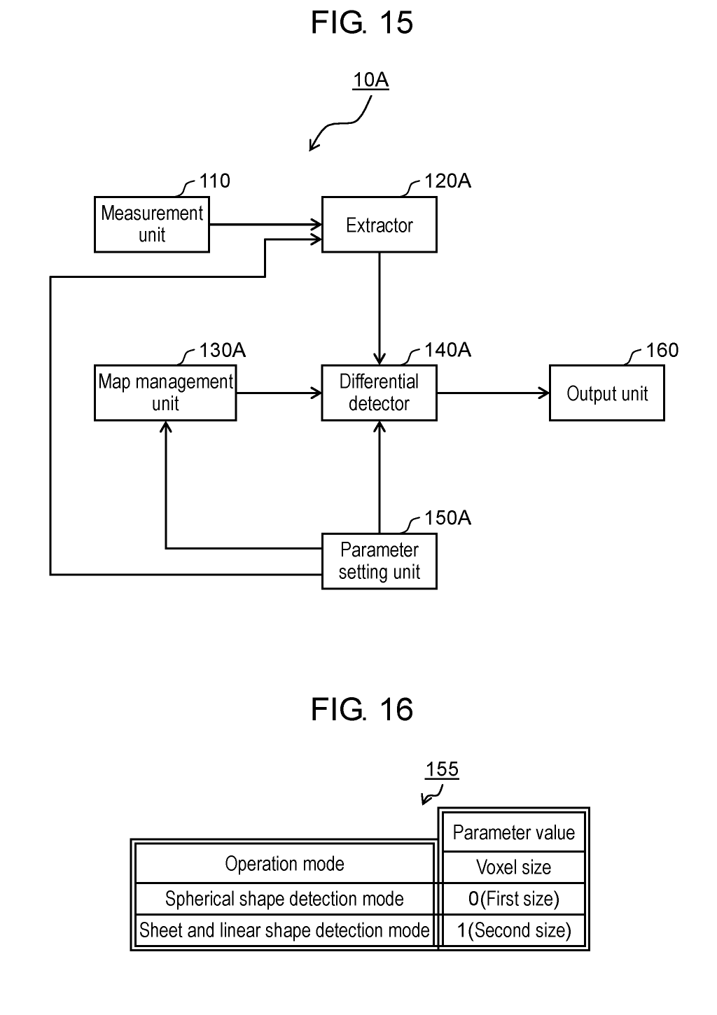

FIG. 15 is a block diagram illustrating a functional configuration of differential detection device 10A.

As shown in FIG. 15, extractor 120 in differential detection device 10 in the first exemplary embodiment is changed to extractor 120A, map management unit 130 to map management unit 130A, differential detector 140 to differential detector 140A, and parameter setting unit 150 to parameter setting unit 150A in differential detection device 10A.

Parameter setting unit 150A stores parameter setting table 155 in addition to the parameter setting tables stored in parameter setting unit 150 in the first exemplary embodiment.

FIG. 16 is a data structure of an example of parameter setting table 155 stored in parameter setting unit 150A.

As shown in FIG. 16, parameter setting table 155 relates the operation modes of differential detection device 10A to a parameter value (numeric value) set to the voxel size (parameter).

In this example, the operation modes of differential detection device 10A include the spherical shape detection mode in which the shape of an object assumed to be causing detected difference is spherical, and the sheet and linear shape detection mode in which the shape of object is sheet or linear. A numeric value (e.g., 0) indicating the first size (e.g., a cube 1 m on each side) is related to the spherical shape detection mode, and a numeric value (e.g., 1) indicating the second size (e.g., a cube 50 cm on each side) is related to the sheet and linear shape detection mode.

Parameter setting unit 150A refers to stored parameter setting table 155, and sets 0 to the voxel size, which is the parameter, when the operation mode input by the user is the spherical shape detection mode. When the operation mode input by the user is the sheet and linear shape detection mode, 1 is set to the voxel size, which is the parameter.

In FIG. 15, extractor 120A further executes the following operation in addition to the operation executed by extractor 120 in the first exemplary embodiment. More specifically, extractor 120A extracts Class 1 attribute information on each of the first measured voxels in a voxel group of the first size when the operation mode set by the user is the spherical detection mode. When the operation mode set by the user is the sheet and linear shape detection mode, extractor 120A extracts Class 2 attribute information on each of the second measured voxels in a voxel group of the second size.

Map management unit 130A manages the attribute information on the voxel group of the first size and the voxel group of the second size with respect to map management unit 130 in the first exemplary embodiment.

More specifically, map management unit 130A manages the Class 1 attribute information on the first map voxels in the voxel group of the first size, and Class 2 attribute information on the second map voxels in the voxel group of the second size.

Map management unit 130A may further manage, for example, attribute information on map voxels in one or more voxel groups with sizes different from the first size and the second size.

Differential detector 140A further executes the following operation in addition to the operation executed by differential detector 140 in the first exemplary embodiment.

More specifically, differential detector 140A detects the presence or the absence of the difference between the Class 1 attribute information on the first measured voxel and the Class 1 attribute information on the first map voxel at a position corresponding to the first measured voxel when the operation mode set by the user is the spherical shape detection mode (i.e., 0 is set to the voxel size parameter). When the operation mode set by the user is the sheet and linear shape detection mode (i.e., 1 is set to the voxel size parameter), differential detector 140A detects presence or absence of a difference between the Class 2 attribute information on the second measured voxel and the Class 2 attribute information on the second map voxel at a position corresponding to the second measured voxel.

[2-2. Operation]

The operation of differential detection device 10A as configured above is detailed below using specific examples.

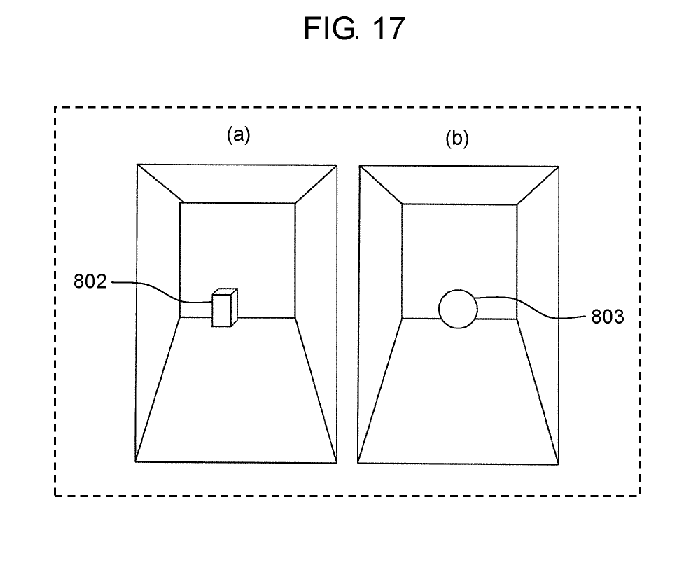

FIG. 17 is an exemplary conceptual diagram illustrating the case when an object that is assumed to be causing detected difference is cuboid 802 with many planes (sheet) ((a) in FIG. 17) and the case of sphere 803 ((b) in FIG. 17).

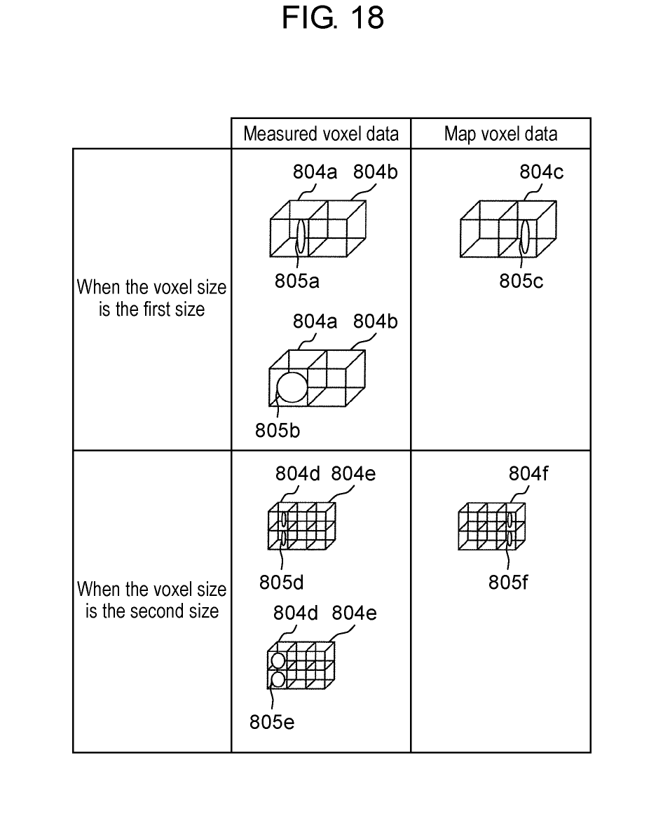

FIG. 18 is an exemplary conceptual diagram illustrating a relation of the measured voxel data and the map voxel data when the voxel size is the first size, and a relation of the measured voxel data and the map voxel data when the voxel size is the second size.

In FIG. 18, measured voxel data 805a is measured voxel data corresponding to cuboid 802 in first measured voxel 804a in the voxel group of the first size, and is classified as a sheet shape.

Measured voxel data 805b is measured voxel data corresponding to sphere 803 in first measured voxel 804a in the voxel group of the first size, and is classified as a spherical shape.

Map voxel data 805c is map voxel data of map voxel 804c in the voxel group of the first size, and is classified as a sheet shape.

Here, first map voxel 804c is a map voxel at a position same as first measured voxel 804b adjacent to first measured voxel 804a.

Measured voxel data 805d is measured voxel data corresponding to cuboid 802 in second measured voxel 804d in the voxel group of the second size, and is classified as a sheet shape.

Measured voxel data 805e is measured voxel data corresponding to sphere 803 in second measured voxel 804d in the voxel group of the second size, and is classified as a spherical shape.

Map voxel data 805f is map voxel data in second map voxel 804f in the voxel group of the second size, and is classified as a sheet shape.

Here, second map voxel 804f is a map voxel at a position same as second measured voxel 804e two voxels next to second measured voxel 804d.

In the description below, the normal direction of measured voxel data 805a and the normal direction of map voxel data 805c have a high similarity, and the normal direction of measured voxel data 805d and the normal direction of map voxel data 805f have a high similarity.

In the voting processing in FIG. 8, when the voxel size is the first size and measured voxel data 805b and map voxel data 805c are compared (Step S31), there is a high possibility that a negative decision is made in Step S32 (Step S32: No) because the shape indicated in measured voxel data 805b and the shape indicated in map voxel data 805c are different. There is thus a high possibility that weight is given to the 27 neighbor map voxels to vote for presence of a difference in Step S36.

Accordingly, when the shape of an object assumed to be causing detected difference is sphere, differential detection device 10A can detect a difference using the voxel with the first size.

Still more, when the voxel sizes is the first size and measured voxel data 805a and map voxel data 805c are compared (Step S31), there is a high possibility that a positive decision is made in Step S32 (Step S32: Yes) because the shape indicated in measured voxel data 805a and the shape indicated in map voxel data 805c are both a sheet shape.

In Step S33, there is a high possibility that a negative decision is made in Step S33 (Step S33: No) because the sheet shape is indicated in measured voxel data 805a.

Still more, there is a high possibility that a positive decision is made in Step S35 (Step S35: Yes) because the normal direction of measured voxel data 805a and the normal direction of map voxel data 805c have a high similarity.

There is thus a high possibility that Step S36 is not executed and no voting for presence of a difference is made by giving weight to the 27 neighbor map voxels.

Accordingly, it is difficult for differential detection device 10A to detect a difference using the voxel with the first size when an object that is assumed to be causing detected difference has a sheet shape.

On the other hand, when the voxel size is the second size, no map voxel data 805f is contained in the 27 neighbor map voxels corresponding to measured voxel data 805d. There is thus a high possibility that a negative decision is made in Step S32 (Step S32: No). Therefore, there is a high possibility that weight is given to the 27 neighbor map voxels to vote for presence of a difference in Step S36.

Accordingly, differential detection device 10A can detect a difference using the voxel with the second size smaller than the first size when an object that is assumed to be causing detected difference has the sheet shape.

[2-4. Effects]

The operation modes of differential detection device 10A may include spherical shape detection mode and the sheet and linear shape detection mode in which shapes of objects assumed to be causing detected difference are different. Extractor 120A extracts Class 1 attribute information on first measured voxel in the voxel group of the first size when the operation mode set by the user is the spherical shape detection mode. When the operation mode set by the user is the sheet and linear detection mode, extractor 120A extracts Class 2 attribute information on the second measured voxel in the voxel group of the second size different from the first size. Map management unit 130A manages the Class 1 attribute information on each of the first map voxels in the voxel group of the first size, and the Class 2 attribute information on each of the second map voxels in the voxel group of the second size. Differential detector 140A detects the presence or the absence of the difference between the Class 1 attribute information on each of the first measured voxels and the Class 1 attribute information on the first map voxel at a position corresponding to applicable first measured voxel when the operation mode set by the user is the spherical detection mode. Still more, differential detector 140A detects the presence or the absence of the difference between the Class 2 attribute information on each of the second measured voxels and the second map voxel at a position corresponding to applicable second measured voxel when the operation mode set by the user is the sheet and linear shape detection mode.

This enables differential detection device 10A to use voxels with different sizes for detecting the presence or the absence of the difference in the operation modes for different shapes of objects that are assumed to be causing detected difference.

The user using differential detection device 10A can set a parameter used in differential detection by differential detection device 10A by setting an operation mode to differential detection device 10A.

Accordingly, user's bothersome setting of parameters for using differential detection device 10A can be eased, compared to the prior art.

### Other Exemplary Embodiments

The first exemplary embodiment and the second exemplary embodiment are described above as embodiments of technology disclosed in the present disclosure. However, the disclosed technology is not limited in any way, and any changes, modifications, additions, and omission to the exemplary embodiments are intended to be embraced therein.

The first exemplary embodiment refers to the case that differential detection device 10 is installed in moving object 20 for use and moves together with movement of moving object 20. However, differential detection device 10 is not necessarily be limited to the use of being installed in moving object 20. For example, differential detection device 10 may be fixed on a ceiling of building for use.

Still more, for example, measurement unit 110 and extractor 120 may have a wireless communication function. In this case, only measurement unit 110 in differential detection device 10 is installed in moving object 20, and other units, including extractor 120 are housed, such as in a casing installed in a floor, within a range capable of communicating with measurement unit 110.

In the first exemplary embodiment, measurement unit 110 is equipped with the stereo camera and depth sensor as the ranging device in the description. However, measurement unit 110 may not necessarily be equipped with both stereo camera and depth sensor as the ranging device. Measurement unit 110 may be equipped only with one of them.

Still more, the ranging device installed in measurement unit 110 is not necessarily be limited to the stereo camera and depth sensor as long as a device has a ranging function.

In the first exemplary embodiment, differential detector 140 detects presence of a difference when, for example, the type of shape indicated in the measured voxel data and that in the map voxel data differ. However, differential detector 140 may detect presence of a difference when there is a significant difference in RGB values indicating color.

In the first exemplary embodiment, map management unit 130 may update stored map voxel data using information on detected difference when differential detector 140 detects the presence or the absence of the difference.

Each of functional blocks in differential detection devices 10 and 10A may be made into one chip by using a semiconductor device, such as IC (Integrated Circuit) and LSI (Large Scale Integration, or partially or entirely made into one chip. Still more, LSI is not the only method of integrating circuits. A dedicated circuit or general-purpose processor is also applicable. Still more, FPGA (Field Programmable Gate Array) that is programmable after manufacturing LSI, and reconfigurable processor that can reconfigure connection and setting of circuit cells inside LSI are also applicable. Furthermore, upon emergence of circuit integration technology that may replace LSI in line with advancement of semiconductor technology or other derivative technology, this technology may also be used for integrating the functional blocks. Biotechnology may also be applicable.

All or part of the aforementioned processing (e.g., procedures shown in FIGS. 6 to 8 and 14) may be achieved by hardware, such as electronic circuits, or software. Processing by software is achieved by executing a control program stored in a memory by a processor in the differential detection device. The control program may be stored in a recording medium for distribution and circulation. For example, a distributed control program may be installed in the differential detection device and executed by the processor in the differential detection device to enable execution of a range of processing (procedures shown in FIGS. 6 to 8 and 14) of the differential detection device. This differential detection device may not include, for example, a ranging device. It can be a computer for executing differential detection by obtaining measurement results from the ranging device.

Embodiments achievable by combining any of components and functions described in the above exemplary embodiments are intended to be embraced in the scope of the present disclosure.

### INDUSTRIAL APPLICABILITY

The present disclosure is broadly applicable to devices for detecting spatial differences.

What is claimed is:

1. A differential detection device configured to detect a spatial difference, comprising:
a measurement unit for performing measurement of a position of each of a plurality of points in a surrounding local space;
an extractor for performing extraction of attribute information on each measured voxel in a plurality of measured voxels that are three-dimensionally arranged and associated with the local space, from a measurement result of the measurement unit;
a map management unit for managing attribute information on each map voxel in a plurality of map voxels that are three-dimensionally arranged and associated with the space shown on a map;
a parameter setting unit for performing setting of a numeric value to a parameter according to an operation mode set by a user;
a differential detector for performing detection of presence or absence of a difference between the attribute information on the measured voxel and the attribute information on the map voxel at a position corresponding to the measured voxel, by using the numeric value set to the parameter; and
an output unit for performing output of a detection result of the differential detector.

2. The differential detection device of claim 1,
wherein
in the detection of the presence or the absence of the difference, the differential detector performs the detection as the presence of the difference when a map voxel at a position corresponding to a measured voxel having significant attribute information does not have significant attribute information.

3. The differential detection device of claim 2,
wherein
the differential detector performs the detection as the presence of the difference when a map voxel at a position adjacent to the position corresponding to the measured voxel having the significant attribute information does not have significant attribute information, when the map voxel at the position corresponding to the measured voxel having the significant attribute information does not have the significant attribute information.

4. The differential detection device of claim 3, wherein at least some of a map voxel group consisted of the plurality of map voxels overlaps with another map voxel group.

5. The differential detection device of claim 1,
wherein
in the detection of the presence or the absence of the difference, the differential detector performs the detection as the presence of the difference when a type of shape indicated in attribute information on the measured voxel and a type of shape indicated in attribute information on the map voxel at the position corresponding to the measured voxel differ.

6. The differential detection device of claim 1,
wherein
in the detection of the presence or the absence of the difference, the differential detector performs the detection as the presence of the difference when the measured voxel and the map voxel at the position corresponding the measured voxel have attribute information indicating a plane or line segment, and a similarity between a normal direction of the plane or line segment indicated in the attribute information on the measured voxel and a normal direction of the plane or line segment indicated in the attribute information on the map voxel is smaller than a predetermined value.

7. The differential detection device of claim 1,
wherein
the measurement is performed for N times (wherein N is a whole number not less than 2),
the extractor performs the extraction every time the measurement unit performs the measurement, and
the differential detector, every time the extractor performs the extraction,
makes voting related to the presence or the absence of the difference, making a positive vote for the presence of the difference when a map voxel at a position corresponding to a measured voxel having significant attribute information does not have significant attribute information, and
performs the detection of the presence or the absence of the difference based on a result of voting for the N times.

8. The differential detection device of claim 7,
wherein
the differential detector makes the positive vote for the presence of the difference when a map voxel at a position adjacent to the position corresponding to the measured voxel having the significant attribute information does not have significant attribute information, when the map voxel at the position corresponding to the measured voxel having the significant attribute information does not have the significant attribute information.

9. The differential detection device of claim 8, wherein at least some of a map voxel group consisted of the plurality of map voxels overlaps with another map voxel group.

10. The differential detection device of claim 1,
wherein
the measurement is performed for N times (wherein N is a whole number not less than 2),
the extractor performs the extraction every time the measurement unit performs the measurement, and
the differential detector, every time the extractor extracts the attribute information on the measured voxel,
makes voting related to the presence or the absence of the difference making a positive vote for the presence of the difference when a type of shape indicated in the attribute information on the measured voxel and a type of shape indicated in the attribute information on the map voxel at a position corresponding to the measured voxel differ from each other, and
performs the detection of the presence or the absence of the difference based on a result of voting for the N times.

11. The differential detection device of claim 1,
wherein
the measurement is performed for N times (wherein N is a whole number not less than 2),
the extractor performs the extraction every time the measurement unit performs the measurement, and
the differential detector, every time the extractor extracts the attribute information on the measured voxel,
makes voting related to the presence or the absence of the difference making a positive vote for the presence of the difference when the measured voxel and the map voxel at the position corresponding to the measured voxel have attribute information indicating a plane or line segment, and a similarity between a normal direction of the plane or line segment indicated in the attribute information on the measured voxel and a normal direction of the plane or line segment indicated in the attribute information on the map voxel is smaller than a predetermined value; and
performs the detection of the presence or the absence of the difference based on a result of voting for the N times.

12. The differential detection device of claim 7,
wherein
the measurement unit is mounted on a moving object,
the operation mode includes a first mode and a second mode having moving speeds of the moving object different from each other,
the parameter setting unit sets a different numeric value to the parameter in the first mode and the second mode of the operation mode, and
the differential detector performs the detection as the presence of the difference when a predetermined relation is established between the numeric value set to the parameter and a result of voting for the N times.

13. The differential detection device of claim 7,
wherein
the measurement unit performs the measurement for the N times in a predetermined cycle,
the operation mode includes a first mode and a second mode with the predetermined cycles different from each other,
the parameter setting unit sets a different numeric value to the parameter in the first mode and the second mode of the operation mode, and
the differential detector performs the detection as the presence of the difference when a predetermined relation is established between the numeric value set to the parameter and a result of voting for the N times.

14. The differential detection device of claim 7,
wherein
the operation mode includes a first mode and a second mode corresponding to a place of use of the differential detection device,
the parameter setting unit sets a different numeric value to the parameter in the first mode and the second mode of the operation mode, and
the differential detector performs the detection as the presence of the difference when a predetermined relation is established between the numeric value set to the parameter and a result of voting for the N times.

15. The differential detection device of claim 7,
wherein
the measurement unit includes a first sensor and a second sensor that can perform the measurement,
the operation mode includes a first mode for using a measurement result of the first sensor and a second mode for using a measurement result of the second sensor,
the extractor extracts attribute information from the measurement result of the first sensor when the operation mode is the first mode, and extracts attribute information from the measurement result of the second sensor when the operation mode is the second mode,
the parameter setting unit sets a different numeric value to the parameter in the first mode and the second mode of the operation mode, and
the differential detector performs the detection as the presence of the difference when a predetermined relation is established between the numeric value set to the parameter and a result of voting for the N times.

16. The differential detection device of claim 15, wherein the first mode and the second mode are operation modes for using the differential detection device indoors.

17. The differential detection device of claim 1,
wherein
the operation mode includes a third mode and a fourth mode respectively corresponding to different object shapes that are assumed to cause a detected difference,
the extractor extracts attribute information on a measured voxel of a first size when the operation mode is the third mode, and extracts attribute information on a measured voxel of a second size different from the first size when the operation mode is the fourth mode,
the map management unit manages attribute information on a map voxel of the first size and attribute information on a map voxel of the second size, and
the differential detector performs the detection of the presence or the absence of the difference,
between the attribute information on the measured voxel of the first size and the attribute information on the map voxel of the first size at a position corresponding to the measured voxel of the first size when the operation mode is the third mode, and
between the attribute information on the measured voxel of the second size and the attribute information on the map voxel of the second size at a position corresponding to the measured voxel of the second size when the operation mode is the fourth mode.

18. The differential detection device of claim 1, wherein the output unit performs the output to display an image representing the detection result on a display device.

19. A differential detection method of detecting a spatial difference, comprising:
a measurement step for measuring a position of each of a plurality of points in a surrounding local space;
an extraction step for extracting attribute information on each measured voxel in a plurality of measured voxels that are three-dimensionally arranged and associated with the local space, from a measurement result in the measurement step;
a reading step for reading attribute information on each map voxel in a plurality of map voxels that are three-dimensionally arranged and associated with the space shown on a map;
a parameter setting step for setting a numeric value to a parameter according to an operation mode set by a user;
a differential detection step for detecting, by using the numeric value set to the parameter, presence or absence of a difference between
the attribute information on the measured voxel, extracted in the extraction step and
the attribute information on the map voxel at a position corresponding to the measured voxel, read in the reading step; and
an output step for outputting a detection result in the differential detection step.
